(19) United States
(12) Patent Application Publication
(10) Pub. No.: US 2008/0056086 A1
(43) Pub. Date: Mar. 6, 2008

(54) LASER DRIVER CIRCUIT AND OPTICAL DISC DEVICE INCLUDING THE LASER DRIVER CIRCUIT

(75) Inventor: Kazuto Kuroda, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/848,045

(22) Filed: Aug. 30, 2007

(30) Foreign Application Priority Data
Aug. 31, 2006 (JP) 2006235910

(51) Int. Cl. G11B 7/00

(52) U.S. Cl. 369/53.26; 372/38.02

(57) ABSTRACT

In order to compute a set value for a laser driver circuit for obtaining laser light having a predetermined irradiation power by using a calibration coefficient indicating manufacturing errors. In an optical disc device including a laser driver circuit according to the present invention, a laser diode emits laser light, a front monitor photo diode receives the emitted laser light to generate a reception light signal, an APC unit of the laser driver circuit compares the thus generated reception light signal with a target value related to the predetermined irradiation power previously set in the laser light to be emitted, a drive of the laser diode is controlled to match the signal to the target value, and a CPU uses at least one calibration coefficient to compute the set value for matching the reception light signal to the target value.

### BACKGROUND OF THE INVENTION

1. Field of the Invention

The present invention relates to a laser driver circuit and an optical disc device including the laser driver circuit. In particular, the invention relates to a laser driver circuit in which an irradiation power of laser light can be calibrated, and an optical disc device including the laser driver circuit.

2. Description of the Related Art

Up to now, a sensitivity of a front monitor photo diode for monitoring an irradiation power, a quantity of incident light, and the like have been adjusted in a step of assembling an optical head in order that a certain irradiation power is obtained during recording and reproduction when a certain value is input to a laser driver circuit.

As an adjustment method employed in such an assembly step for the optical head, the following technique has been proposed (for example, refer to Japanese Unexamined Patent Application Publication No. 2004-63045).

According to the adjustment method proposed in Japanese Unexamined Patent Application Publication No. 2004-63045, when a laser of a laser diode is turned OFF, a monitor output value at the time of turning OFF the laser is measured by using of a front monitor photo diode. The laser diode is driven while a set value for setting a drive level at which the laser diode is driven is set to a predetermined default value. The set value is decreased gradually by a predetermined interval from the default value to drive the laser diode. A reference set value for setting the drive level of the laser diode at which a monitor output value of the front monitor photo diode becomes equal to the monitor output value at the time of turning OFF the laser is detected. Then, a set value for driving the laser diode is set while using this reference set value as the reference.

As a result, a step flow inspection at the time of producing the optical heads can be omitted, and also the irradiation power of the laser of the laser diode can be compensated in correspondence with the variation of the optical heads and the laser driver circuits.

However, according to the conventional adjustment method, the adjustment is performed so that the error of the irradiation power falls within ±5%, and thus it takes much time to conduct the adjustment for the sensitivity of the front monitor photo diode for monitoring the irradiation power, the incident light quantity, and the like.

In particular, in an optical disc device using a blue laser, in order to maintain the compatibility with the conventional recording media (for example, a DVD (Digital Versatile Disc), a CD (Compact Disc), etc.), lasers corresponding to the respective recording media are required, and lasers for the three wavelengths in total are mounted to the optical head. Thus, it takes further time to conduct this adjustment.

In addition to the above, the error of the irradiation power is influenced by various manufacturing errors (dispersions in manufacture) such as the variation of the incident light quantity ratio of the front monitor photo diode with respect to the outgoing light quantity of the laser caused by the dispersions in manufacture and mounting of the laser diodes and the half mirrors, the variation of the reception light quantity caused by the dispersions in mounting of the front monitor photo diodes, the change of the reception light sensitivity and the output voltage off-set caused by the dispersions in manufacture of the front monitor photo diodes, the gain variation caused by the dispersions in manufacture of the front monitor photo diodes, and the off-set variation in the sample-and-hold, the peak hold, and the variable gain circuit. Therefore, according to the conventional adjustment method, it is necessary to adjust such various manufacturing errors one by one.

For example, the sensitivity variation of the reception light signal output by the front monitor photo diode is adjusted with use of the sensitivity adjustment variable resistance that is provided to the front monitor photo diode when the optical head is assembled. However, as it is necessary to suppress the variation of the irradiation power from the objective lens within ±5% (approximately several %) when a given set value is input to respective DA (digital-analog) converters for APC, in a case where recording and reproduction are performed while corresponding to the recording media of plural lengths such as the CD, the DVD, and an HD DVD, a variable resistance for conducting the adjustment for the respective wavelengths is required, which leads to a difficulty in miniaturizing the optical head. As a result, an increase in costs for the adjustment at the time of assembling the optical heads can not be avoided.

Also, in a case where adjustment is conducted for the gain variation caused by the dispersions in manufacture of the front monitor photo diodes, and the off-set variation in the sample-and-hold, the peak hold, the variable gain circuit, the variation in transconductances of a current source, and the like, the adjustment is effected by suppressing the manufacturing dispersion. However, in a configuration where the laser driver circuit is integrated into one IC (Integrated Circuit), a large number of elements that need to be adjusted for suppressing the manufacturing dispersion are present in one IC, which leads an opposite effect causing a difficulty in design and manufacture. Thus, the costs are increased along with the yield loss.

Furthermore, in order to ensure a dynamic range of the reception light signal of the front monitor photo diode for a purpose of a high accuracy of an APC loop, when the sensitivity of the front monitor photo diode is switched between at the time of recording and at the time of reproduction, only one of the plurality of switching sensitivities is adjusted in the sensitivity adjustment by using a sensitivity adjusting variable resistor. Thus, in order to suppress the reception light variation in a state of switching into a sensitivity other than the sensitivity to be adjusted, suppression in the manufacturing dispersion of the sensitivity errors and the output offset errors before and after the switching is required in the front monitor photo diode, which leads to a difficulty in design and manufacture. As a result, the costs are increased along with the yield loss.

The above-mentioned problems cannot be solved with the adjustment method proposed in Japanese Unexamined Patent Application Publication No. 2004-63045.

### SUMMARY OF THE INVENTION

Accordingly, the present invention has been made in view of the above-mentioned circumstances, and an object of the present invention is to provide a laser driver circuit capable of computing a set value for a laser driver circuit for obtaining laser power with a predetermined irradiation power by using a calibration coefficient representing a manufacturing error and an optical disc device including this laser driver circuit.

According to an aspect of the present invention, in order to solve the above-mentioned matters, there is provided a laser driver circuit that includes a light emitting configured to emit laser light; a light receiving configured to receive the laser light emitted from the light emitting unit and generate a reception light signal; and a control configured to compare the reception light signal generated by the light receiving unit with a target value related to an irradiation power previously set for the laser light emitted from the light emitting unit and to control a drive of the light emitting unit so that the reception light signal matches the target value, in which the control unit is configured to control the light emitting unit so that the reception light signal matches the target value on the basis of a set value which is computed by using at least one calibration coefficient for matching the reception light signal to the target value.

According to the another aspect of the present invention, in order to solve the above-mentioned matters, there is provided an optical disc device that includes a laser driver circuit, the laser driver circuit including a light emitting unit configured to emit laser light; a light receiving unit configured to receive the laser light emitted from the light emitting unit and generate a reception light signal; a control unit configured to compare the reception light signal generated by the light receiving unit with a target value related to an irradiation power previously set for the laser light emitted from the light emitting unit and to control a drive of the light emitting unit so that the reception light signal matches the target value; and a computation unit configured to compute a set value for matching the reception light signal to the target value by using at least one calibration coefficient.

In the laser driver circuit according to the present invention, the laser light is emitted, the emitted laser light is received, the reception light signal is generated, the thus generated reception light signal is compared with the target value related to the irradiation power previously set for the laser light emitted from the light emitting unit, the drive of the light emitting unit is controlled so that the reception light signal matches the target value, and the light emitting unit is controlled by the control unit so that the reception light signal matches the target value on the basis of a set value which is computed by using at least one calibration coefficient for matching the reception light signal to the target value.

In the optical disc device including the laser driver circuit according to the present invention, the laser light is emitted, the emitted laser light is received, the reception light signal is generated, the thus generated reception light signal is compared with the target value related to the irradiation power previously set for the laser light emitted from the light emitting unit, the drive of the light emitting unit is controlled so that the reception light signal matches the target value, and a set value for matching the reception light signal to the target value is computed by using at least one calibration coefficient.

### BRIEF DESCRIPTION OF THE DRAWINGS

In the accompanying drawings:

FIG. 1 is a block diagram of an internal configuration of an optical disc device according to an embodiment of the present invention;

FIG. 2 illustrates an internal circuit configuration of the laser driver circuit of FIG. 1;

FIG. 3 is a block diagram of an internal configuration of a power calibration device according to an embodiment of the present invention;

FIG. 4 is a flowchart illustrating a first calibration coefficient calculation process in the power calibration device of FIG. 3;

FIG. 5 is a graph illustrating a relation between an irradiation power and an AD conversion value;

FIGS. 6A and B illustrate other configurations of an optical head of FIG. 1;

FIG. 7 is a flowchart illustrating a second calibration coefficient calculation process in the optical disc device of FIG. 1;

FIG. 8 is a graph illustrating a relation between the irradiation power and a set value for a READ APC DAC;

FIG. 9 is a flowchart illustrating a third calibration coefficient calculation process in the optical disc device of FIG. 1;

FIG. 10 illustrates a relation among a READ current, a BOTTOM current, and an LD drive current;

FIG. 11 is a graph illustrating a relation between a set value for a BOTTOM AAC DAC and the AD conversion value;

FIG. 12 is a flowchart illustrating a fourth calibration coefficient calculation process in the optical disc device of FIG. 1;

FIG. 13 is a graph illustrating a relation between the AD conversion value and a set value for a READ AAC DAC;

FIG. 14 is a flowchart illustrating a set value computation process in the optical disc device of FIG. 1;

FIG. 15 is a flowchart illustrating another second calibration coefficient calculation process in the optical disc device of FIG. 1; and

FIG. 16 is a block diagram illustrating another internal circuit configuration of the optical disc device according to the present invention.

### DESCRIPTION OF THE PREFERRED EMBODIMENTS

Hereinafter, embodiments of the present invention will be described with reference to the drawings.

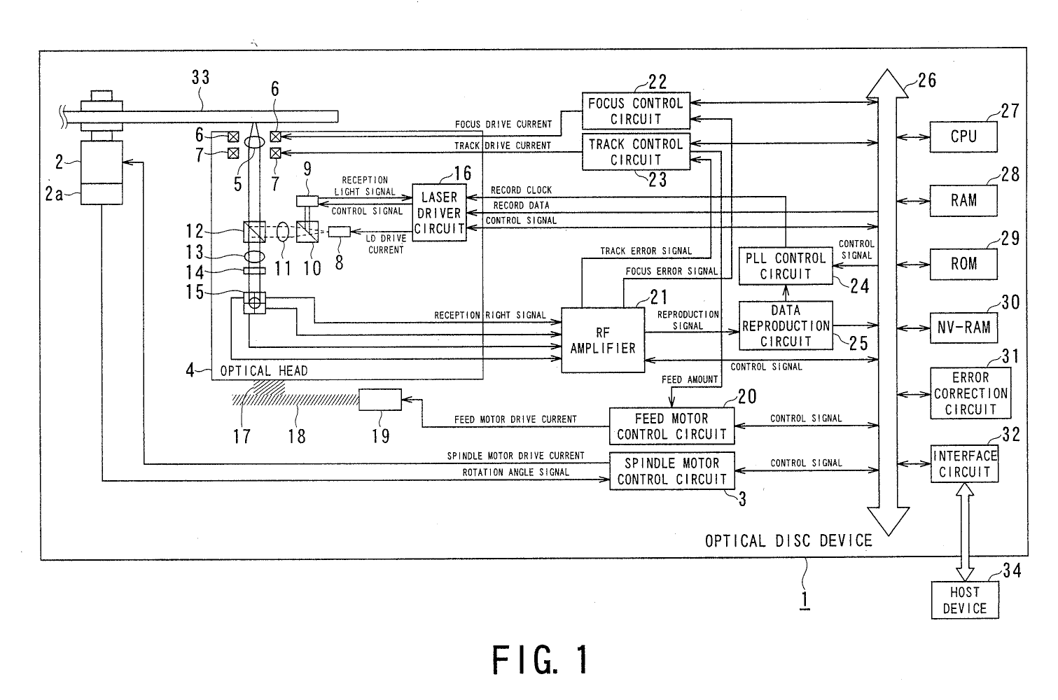

FIG. 1 illustrates a configuration of an optical disc device 1 according to the present invention.

The optical disc device 1 is adapted to record and regenerate information with respect to an optical disc 33 functioning as an information recording medium such as a DVD (Digital Versatile Disc). On the optical disc 33, a gutter is carved concentrically or spirally. A concave part of the gutter is called “land” and a convex part thereof is called “groove”. One circle of the groove or the land is called “track”. User data is recorded on the optical disc 33 along with this track (only the groove, or the groove and the land) by forming record marks while irradiated with laser light whose intensity is modulated. The data reproduction is performed by detecting changes in reflected light intensity caused by the record marks on the track with irradiation of laser light having a read power which is weaker than the power during the recording along with the track. Deletion of the recorded data is performed by crystallizing the recording layer with irradiation of laser light having an erase power which is stronger than the read power along with the track.

The optical disc 33 is rotated and driven by the spindle motor 2. A rotation angle signal is output from a rotary encoder 2a provided to the spindle motor 2 to a spindle motor control circuit 3. When the spindle motor 2 makes one revolution, the rotation angle signal generates five pulses, for example. As a result, the spindle motor control circuit 3 can determine the rotation angle and the number of revolutions of the spindle motor 2 on the basis of the rotation angle signal input from the rotary encoder 2a.

Record or reproduction of information with respect to the optical disc 33 is performed by an optical head 4. The optical head 4 is connected via a gear 17 and a screw shaft 18 to a feed motor 19, and the feed motor 19 is controlled by a feed motor control circuit 20. While the feed motor 19 is rotated by a feed motor driver current supplied from the feed motor control circuit 20, the optical head 4 is moved in a radius direction of the optical disc 33.

In the optical head 4, an objective lens 5 is provided while being supported by a wire or a leaf spring not shown in the drawing. The objective lens 5 is capable of moving in a focusing direction (an optical axis direction of the lens) by way of drive of a drive coil 7, and also capable of moving in a tracking direction (a direction orthogonal to the optical axis direction of the lens) by way of drive of a drive coil 6.

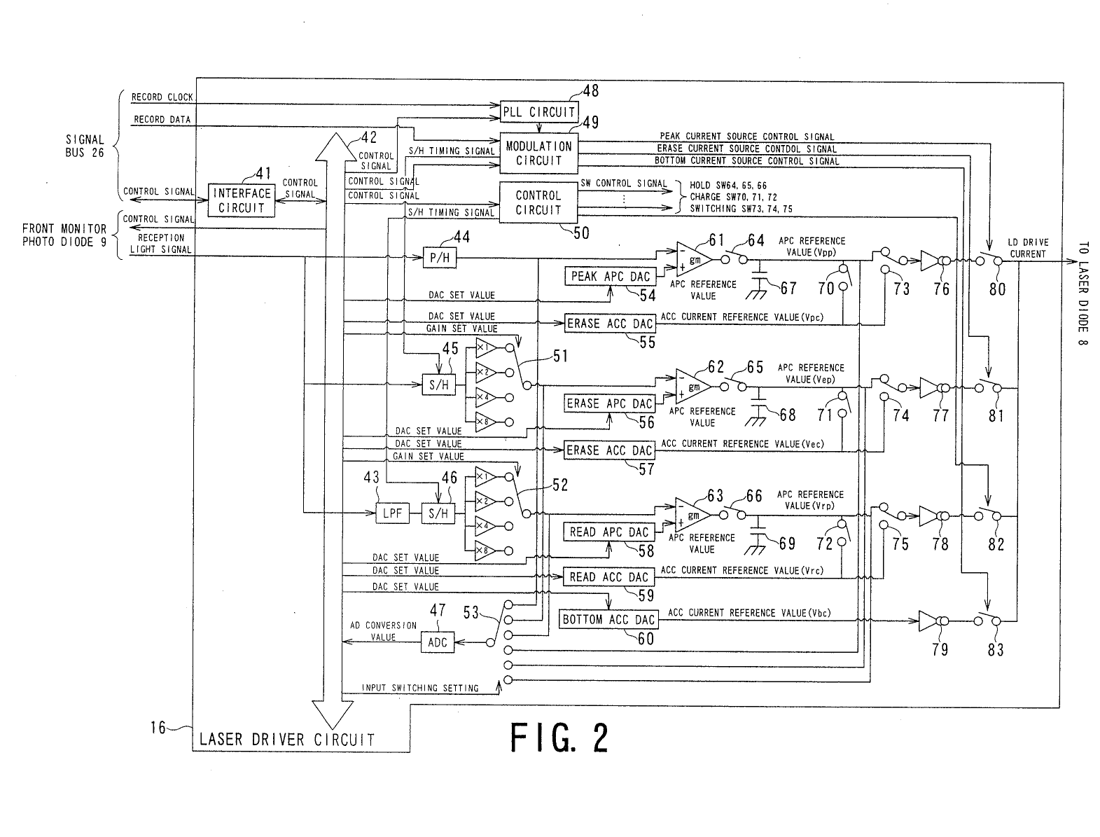

A laser driver circuit 16 supplies a write signal to a laser diode (laser light emitting element) 8 during information recording (when record marks are formed) on the basis of record data supplied from a host device 34 via an interface circuit 32. Also, the laser driver circuit 16 supplies a read signal which is smaller than the write signal to the laser diode 8 during information reading. A detailed configuration of the laser driver circuit 16 will be described later with reference to FIG. 2.

A front monitor photo diode 9 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 obtains reception light signal supplied from the front monitor photo diode 9 and controls the laser diode 8 on the basis of the thus obtained reception light signal so that light emission is performed at a laser power (irradiation power) during the reproduction, a laser power during the recording, and a laser power during the deletion which are previously set by a CPU 27.

The laser diode 8 emits laser light in accordance with the signal supplied from the laser driver circuit 16. The optical disc 33 is irradiated with the light emitted from the laser diode 8 via a collimator lens 11, a half prism 12, and the objective lens 5. A reflect light from the optical disc 33 is guided to an light detecting element 15 via the objective lens 5, the half prism 12, a collecting lens 13, and a cylindrical lens 14.

The light detecting element 15 is composed, for example, of a four-partitioning light detection cell. The light detecting element 15 generates a detection signal and outputs the thus generated detection signal to an RF amplifier 21. The RF amplifier 21 processes the detection signal from the light detecting element 15 to generate a focus error signal (FE) representing an error from the just focus, a tracking error signal (TE) representing an error between the beam spot center of the laser light and the center of the track, and a regeneration signal (RF) that is a full addition signal of the detection signals. The RF amplifier 21 respectively supplies the focus error signal (FE), the tracking error signal (TE), and the regeneration signal (RF) thus generated to a focus control circuit 22, a track control circuit 23, and a data reproduction circuit 25.

The focus control circuit 22 generates a focus drive signal in accordance with the focus error signal (FE) supplied from the RF amplifier 21 and supplies the thus generated focus drive signal to the drive coil 6 in a focusing direction. As a result, focus servo is performed so that the laser light always has the just focus on a recording film prepared on the optical disc 33.

The track control circuit 23 generates a track drive signal in accordance with the tracking error signal (TE) supplied from the RF amplifier 21 and supplies the thus generated track drive signal the drive coil 7 in a tracking direction. As a result, tracking servo is performed so that the laser light always has the trace on the track formed on the optical disc 33.

While the focus servo and the tracking servo described above are performed, the regeneration signal (RF) that is the full addition signal of the detection signals from the light detecting element 15 (each of the light detection cells) reflects changes in the reflect light from pits or the like formed on the track of the optical disc 33 in accordance with the record information. This regeneration signal is supplied to the data reproduction circuit 25. The data reproduction circuit 25 regenerates the record data on the basis of a reproduction clock signal from a PLL (Phase Locked Loop) circuit 24.

It should be noted that when the objective lens 5 is controlled by the track control circuit 23, the feed motor 19 is controlled by the feed motor control circuit 20 so that the objective lens 5 is located at a predetermined position in the optical head 4.

The spindle motor control circuit 3, the laser driver circuit 16, the feed motor control circuit 20, the focus control circuit 22, the track control circuit 23, the PLL control circuit 24, the data reproduction circuit 25, an error correction circuit 31, and the like are controlled by the CPU (Central Processing Unit) 27 via a signal bus 26. The CPU 27 executes various processes on the basis of various application programs loaded on an RAM (Random Access Memory) 28 from an application program stored in an ROM (Read Only Memory) 29 in accordance with an operation command supplied from the host device 34 via the interface circuit 32. Also, the CPU 27 generates various control signals and supplies the signals to the respective components to control the optical disc device 1 in an overall manner. Furthermore, the CPU 27 appropriately refers to a parameter for each optical disc device 1 which is stored in a non-volatile memory (NV-RAM) 30.

FIG. 2 illustrates a circuit configuration inside the laser driver circuit 16 of FIG. 1.

The laser driver circuit 16 is roughly composed of three units, that is, a waveform generation unit for generating a record waveform from a record clock and record data and performing switch over of current sources in accordance with the record form, an APC control unit for controlling a current to the laser diode 8 so that the power becomes the irradiation power that is instructed from the CPU 27 at the time of recording and reproduction, and a control unit for interpreting the control signal from the signal bus 26 and performing a control on the laser driver circuit 16.

First of all, the waveform generation unit is composed, for example, of the PLL circuit 48, a modulation circuit 49, and the like. The PLL circuit 48 obtains a record clock via the signal bus 26 and generates a timing signal necessary to the modulation circuit 49 by using the thus obtained record clock. The modulation circuit 49 interprets the record data obtained via the signal bus 26, generates a record waveform in accordance with the control signal supplied via an internal bus 42 from the CPU 27, and divides the signal into current source control signals (a PEAK current source control signal, an ERASE current source control signal, and a BOTTOM current source control signal) representing ON/OFF of the respective current sources (one of current sources 76, 77, and 79). The thus divided three current source control signals are respectively connected to a PEAK SW 80, an ERASE SW 81, and a BOTTOM SW 83. In accordance with the current source control signals, the respective current sources (one of the current sources 76, 77, and 79) are turned ON/OFF. As a result, strong and weak levels of the LD drive current to be supplied to the laser diode are generated and the intensity modulation of the irradiation power is executed at the time of recording. It should be noted that a READ SW 82 is a switch of a current source to be turned ON mainly at the time of reproduction. The READ SW 82 is turned ON/OFF by a control circuit 50 in response to a recording and reproduction switching signal contained in the control signal from the signal bus 26.

Next, the APC control unit has similar configurations for PEAK, ERASE, and READ, and a description will be given only to ERASE herein.

In the APC control unit of ERASE, the reception light signal from the front monitor photo diode 9 is compared with an output of an ERASE APC DAC 56 previously set by ERASE irradiation power information contained in the control signal supplied via the signal bus 26 from the CPU 27 by a comparison amplifier 62, and a control is performed on the current source 77 so that the irradiation power when the ERASE SW 81 is ON is matched to the ERASE irradiation power previously set in accordance with the ERASE irradiation power information.

At the time of recording, the respective current sources (one of the current sources 76 to 79) are turned ON/OFF at a high speed. In order that the output of the front monitor photo diode 9 when the ERASE irradiation power is output from the laser diode 8 is input to the comparison amplifier 62, with use of a sample hold circuit S/H 45, only when the ERASE irradiation power is output from the laser diode 8, the output of the front monitor photo diode 9 is taken in. At other cases, the output is held.

In addition, depending on the recording media, the ERASE irradiation power becomes 1/10 of the magnitude of the PEAK irradiation power in some cases. When the light quantity—voltage calibration coefficient (reception light sensitivity) is adjusted so that the front monitor photo diode 9 is not saturated at the time of the highest PEAK irradiation power, an input voltage to the comparison amplifier 62 and a set value for the ERASE APC DAC 56 may be too small in some cases, and therefore a gain switching SW 51 is provided. As a result, an appropriate set value depending on a type of the recording media which is determined by the CPU 27 is set.

A CBW 68 is a time constant capacitor for adjusting the control bandwidth. As a reference voltage to the current source 77 accumulates in the CBW 68, in order to make a transient variation at the rising of the APC small, such a method can be employed that a voltage value corresponding to an appropriate current value is computed by the CPU 27 and the computed value is supplied in a feed forward manner. For realization of the feed forward manner, a hold SW 65 and a charge SW 71 are provided.

As a representative use example, first, the hold SW 65 is opened when the recording is not performed. A voltage value corresponding to an appropriate current value is computed by the CPU 27 and the computed value is set in an ERASE ACC DAC 57 via the internal bus 42 in response to the control signal from the signal bus 26. Next, the charge SW 71 is closed and a reference voltage is accumulated in the CBW 68. After that, at the same when recording is started and the APC starts, the hold SW 65 is closed and the charge SW 71 is opened. Thus, a difference with respect to a necessary current for outputting a current by the amount of the accumulated voltage and the original ERASE irradiation power is compensated by the comparison amplifier 62, and as a result it is possible to shorten a time during which the transient variation falls within an allowable irradiation power error range.

The switching SW 74 is a switch for performing the irradiation power control with use of a feedback loop (APC control) or for switching the selection (APC control) while the voltage value corresponding to the appropriate current value is computed by the CPU 27. The switching is determined by the CPU 27 in accordance with a situation. Then, on the basis of the control signal of the CPU 27 which is supplied via the internal bus 42 from the signal bus 26, the control circuit 50. The operation of the APC unit having such a configuration is described in detail in Japanese Patent Application 2006-152758.

Furthermore, mainly, the control unit plays a role of transmitting the control signal determined by the CPU 27 to the respective operational components. The control unit is composed of an interface circuit 41, the internal bus 42, and the control circuit 50.

In a case where the optical disc device 1 performs the recording and reproduction while corresponding to a plurality of recording media such as the CD, the DVD, and the HD DVD, the front monitor photo diode 9 needs to correspond to a wide wavelength and a change in the quantity of the reception light. For that reason, a reception light sensitivity control signal for controlling the reception light sensitivity is supplied to the front monitor photo diode 9. This reception light sensitivity control signal is generated in accordance with the determination on switching made by the CPU 27. The reception light sensitivity control signal is supplied to the front monitor photo diode 9 via the internal bus 42 from the signal bus 26. In addition, in conjunction with a recording and reproduction switching signal contained in the control signal from the signal bus 26, the reception light sensitivity control signal generated from the CPU 27 may be changed in the interface circuit 41 to be output to the front monitor photo diode 9.

It should be noted that in the optical disc device 1 illustrated in FIG. 1, in order to ensure the recording waveform quality along with the increase in the recording speed, the laser driver circuits 16 are integrated into one IC to be mounted on the optical head 4 but the configuration is not limited to the above-mentioned example. Such a configuration may be adopted that components equivalent to the current sources 76 to 79, the PEAK SW 80, the ERASE SW 81, the READ SW 82, and the BOTTOM SW 83 are mounted on the optical head 4 and other components are mounted outside the optical head 4.

In addition, as illustrated in FIGS. 1 and 2, one laser diode 8 is connected to the laser driver circuit 16, but in a case where the optical disc device performs the recording and reproduction while corresponding to the plurality of recording media such as the CD, the DVD, and the HD DVD, a plurality of the laser diodes 8 may be mounted to the laser driver circuit 16. In such a case as well, only one laser diode 8 can emit the light at once. Therefore, even in a case of the laser driver circuit 16 that drives the plural laser diodes 8, if the operating component is only focused on, the configuration is similar to the case of driving the single laser diode 8.

Incidentally, according to the conventional adjustment method, the adjustment is performed so that the error of the irradiation power falls within ±5%. Thus, it takes much time to perform the adjustment for the sensitivity of the front monitor photo diode for monitoring the irradiation power, the incident light quantity, and the like.

In other words, the error of the irradiation power is influenced by various manufacturing errors (dispersions in manufacture) the variation of the incident light quantity ratio of the front monitor photo diode with respect to the outgoing light quantity of the laser caused by the dispersions in manufacture and mounting of the laser diodes and the half mirrors, the variation of the reception light quantity caused by the dispersions in mounting of the front monitor photo diodes, the change of the reception light sensitivity and the output voltage off-set caused by the dispersions in manufacture of the front monitor photo diodes, the gain variation of the variable gain caused by the dispersions in manufacture of the laser driver circuits, and the off-set variation in the sample-and-hold, the peak hold, and the variable gain circuit. Therefore, according to the conventional adjustment method, it is necessary to adjust such various manufacturing errors one by one.

For example, the sensitivity variation of the reception light signal output by the front monitor photo diode is adjusted with use of the sensitivity adjustment variable resistance that is provided to the front monitor photo diode when the optical head is assembled. However, as it is necessary to suppress the variation of the irradiation power from the objective lens within ±5% (approximately several %) when a given set value is input to respective DA (digital-analog) converters for APC, in a case where recording and reproduction are performed while corresponding to the recording media of plural lengths such as the CD, the DVD, and the HD DVD, it is necessary to provide a variable resistance for performing the adjustment for the respective wavelengths, which leads to the difficulty of miniaturization of the optical head. As a result, the costs in the adjustment at the time of assembling the optical head are unavoidably increased.

In addition, for the adjustment in terms of the gain variation of the variable gain due to the manufacturing dispersion of the laser driver circuits, the off-set variation in the sample-and-hold, the peak hold, the variable gain circuit, the variation of the transconductor of the current source, and the like, the adjustments are performed by suppressing the manufacturing dispersion. However, in a configuration where the laser driver circuit is integrated into one IC (Integrated Circuit), a large number of elements that need to be adjusted for suppressing the manufacturing dispersion are present in one IC, which leads an opposite effect causing a difficulty in design and manufacture. Thus, the costs are increased along with the yield loss.

Furthermore, in order to ensure a dynamic range of the reception light signal of the front monitor photo diode for a purpose of a high accuracy of an APC loop, when the sensitivity of the front monitor photo diode is switched between at the time of recording and at the time of reproduction, only one of the plurality of switching sensitivities is adjusted in the sensitivity adjustment by using a sensitivity adjusting variable resistor. Thus, in order to suppress the reception light variation in a state of switching into a sensitivity other than the sensitivity to be adjusted, suppression in the manufacturing dispersion of the sensitivity errors and the output offset errors before and after the switching is required in the front monitor photo diode, which leads to a difficulty in design and manufacture. As a result, the costs are increased along with the yield loss.

Also, in a case of performing the control on the irradiation power at the time of the recording and reproduction (the APC control, the ACC control, and the like), the process is influenced by such various manufacturing errors.

In view of the above, the sensitivity shift of the front monitors due to the mounting or the manufacturing errors of elements is not adjusted. Instead, the above-mentioned manufacturing errors themselves are previously measured at the time of assembling the optical heads 4 or assembling the drives, the calibration coefficient representing the measured manufacturing errors is calculated, and thereafter, at the time of the recording and reproduction, this calibration coefficient is used to compute the reference value for obtaining the laser light having the predetermined irradiation power with respect to the inside of the laser driver circuit. As a result, at the time of the recording and reproduction, the sensitivity shift of the front monitors due to the mounting or the manufacturing errors of elements can be appropriately calibrated. Therefore, homogenization of the process flow time and simplification in the step of assembling the optical heads 4, the step of assembling the drives, and the like are achieved, and also the plural points are to be measured instead of adjusting one point as in the conventional manner. Thus, it is possible to eliminate the influence of the off-set inclination error due to the element dispersions at the same time, thereby easing the accuracy required by the parts. As a result, it is possible to improve the yield and reduce the costs. Hereinafter, before a reference value computing method with use of calibration coefficients will be described, first of all, methods of calculating respective calibration coefficients are described.

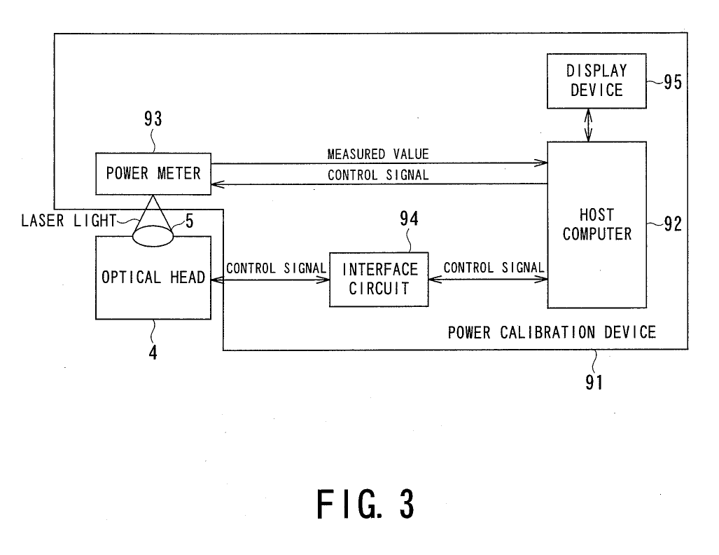

FIG. 3 illustrates a configuration of a power calibration device 91 according to the present invention.

As illustrated in FIG. 3, the power calibration device 91 is composed of a host computer 92 for calculating a first calibration coefficient, a power meter 93 for measuring the irradiation power (intensity) of the laser light irradiated from the objective lens 5 of the optical head 4, an interface circuit 94 for connecting the optical head 4 with the host computer 92, and a display device 95 for displaying the calculated first calibration coefficient.

It should be noted that a detailed internal configuration of the optical head 4 is similar to the configurations of FIGS. 1 and 2, and a description thereof will be omitted to avoid the repetition.

The host computer 92 is composed of, for example, a memory unit structured by a CPU (Central Processing Unit), a ROM (Read Only Memory), a RAM (Random Access Memory), an HDD (Hard Disc Drive), and the like. The CPU executes various processes in accordance with a program stored in the ROM or various application programs loaded on the RAM from the memory unit. At the same time, the CPU generates various control signals and supplies the signals to the respective units, thereby controlling the power calibration device 91 in an overall manner. The RAM appropriately stores data necessary for the CPU to execute various processes and the like.

The optical head 4 is connected to the host computer 92 via the interface circuit 94 at the time of executing a first calibration coefficient calculation process. The power meter 93 measures the irradiation power (intensity) of the laser light irradiated from the objective lens 5 of the optical head 4 and outputs the measured value to the host computer 92. The display device 95 displays a power calibration state to be executed and controlled by the program in the host computer 92 for an operator.

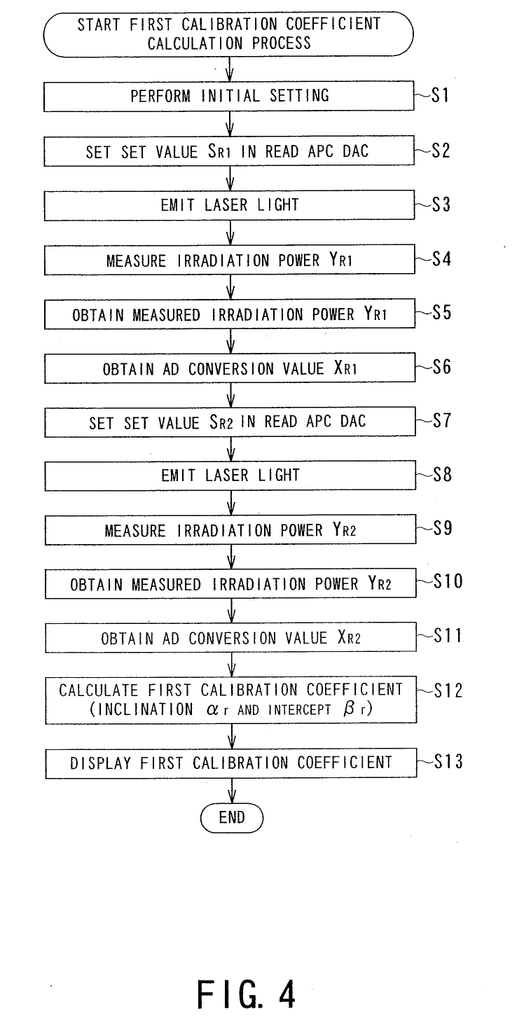

While referring to a flowchart of FIG. 4, the first calibration coefficient calculation process in the power calibration device 91 will be described. This first calibration coefficient calculation process is started when, in the optical head assembly step, the operator operates an input unit (not shown) in the power calibration device 91 and issues an instruction to start the first calibration coefficient calculation process. It should be noted that in the first calibration coefficient calculation process described with use of the flowchart of FIG. 4, a case of using the current source 78 that is mainly used at the time of reproduction will be described.

In Step S1, with respect to the laser diode 8 and the laser driver circuit 16 inside the optical head 4, the host computer 92 uses the current source 78 to perform the initial setting necessary for irradiating the laser light from the laser diode 8.

In Step S2, the host computer 92 generates a READ APC DAC set control signal for setting a set value S_{R1} as a DAC set value in a READ APC DAC 58 and outputs the thus generated READ APC DAC set control signal to the optical head 4.

On the basis of the READ APC DAC setting control signal input from the host computer 92, the optical head 4 sets the set value S_{R1} in the READ APC DAC 58 as the DAC set value.

In Step S3, in accordance with the control of the host computer 92, the laser driver circuit 16 of the optical head 4 supplies an LD drive current generated with use of the set value S_{R1} thus set, to the laser diode 8. The laser diode 8 of the optical head 4 uses the LD drive current supplied from the laser driver circuit 16 to emit the laser light via the objective lens 5 for irradiating the power meter 93 with the laser light.

In Step S4, the power meter 93 measures the irradiation power of the laser light irradiated from the laser diode 8 and supplies the thus measured irradiation power Y_{R1} to the host computer 92.

In Step S5, the host computer 92 obtains the irradiation power Y_{R1} supplied from the power meter 93.

Herein, the laser light is emitted from when the laser diode 8 of the optical head 4, the front monitor photo diode 9 of the optical head 4 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 of the optical head 4 obtains the reception light signal supplied from the front monitor photo diode 9, performs AD (analog-digital) conversion on the reception light signal obtained by an ADC 47 via an LPF 43 and an S/H 46, and supplies the AD conversion value X_{R1} after the conversion to the host computer 92 via the interface circuit 94.

In Step S6, the host computer 92 obtains the AD conversion value X_{R1} supplied from the optical head 4 to the interface circuit 94.

Next, in Step S7, similarly, the host computer 92 generates a READ APC DAC setting control signal for setting a set value S_{R2} in the READ APC DAC 58 as the DAC set value and outputs the thus generated READ APC DAC set control signal to the optical head 4.

On the basis of the READ APC DAC setting control signal input from the host computer 92, the optical head 4 sets the set value S_{R2} in the READ APC DAC 58 as the DAC set value.

In Step S8, the laser driver circuit 16 of the optical head 4 supplies an LD drive current generated with use of the set value S_{R1} thus set, to the laser diode 8. The laser diode 8 of the optical head 4 uses the LD drive current supplied from the laser driver circuit 16 to emit the laser light via the objective lens 5 for irradiating the power meter 93 with the laser light.

In Step S9, the power meter 93 measures the irradiation power of the laser light irradiated from the laser diode 8 and supplies the thus measured irradiation power Y_{R2} to the host computer 92.

In Step S10, the host computer 92 obtains the irradiation power Y_{R2} supplied from the power meter 93. In Step S11, the host computer 92 obtains an AD conversion value X_{R2} supplied from the optical head 4 to the interface circuit 94.

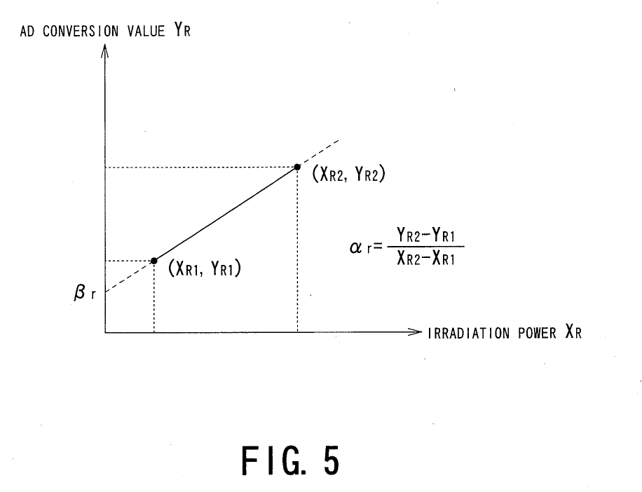

In Step S12, the host computer 92 uses the irradiation power Y_{R1} and the AD conversion value X_{R1} obtained when the set value S_{R1} is set in the READ APC DAC 58 as the DAC set value and the irradiation power Y_{R1} and the AD conversion value X_{R1} obtained when the set value S_{R1} is set in the READ APC DAC 58 as the DAC set value to approximate a relation between the irradiation power Y_{R} and the AD conversion value X_{R} by way of a straight line as illustrated in FIG. 5, and its inclination αᵣ [mW/digit] and its intercept βᵣ [digit] as the first calibration coefficient.

In Step S13, the host computer 92 causes the display device 95 to display the calculation result of the first calibration coefficient. The display device 95 displays the calculation result of the first calibration coefficient in accordance with the control of the host computer 92. As a result, the operator can find out the calculation result of the first calibration coefficient of the optical head 4 that is the power calibration target.

It should be noted that in the first calibration coefficient calculation process performed on the basis of the flowchart of FIG. 4, a comparison amplifier 63 is used to execute the automatic power control (the APC control) and the perform the irradiation from the laser diode 8. However, a switching over SW 75 may be set on a READ ACC DAC 59 side to change the value of the READ ACC DAC 59 so that the irradiation is performed from the laser diode 8 by way of the constant current control (the ACC control).

Also, in the first calibration coefficient calculation process performed on the basis of the flowchart of FIG. 4, the irradiation power and the AD conversion value are obtained at two points for the straight-line approximation, but the calibration coefficient may be calculated through the least square approximation through the obtainment at more than two points. As a result, it is possible to suppress the influence caused by the observation noise.

Herein, as the front monitor photo diode 9 is mounted without a special positional adjustment such as fitting into a notch part, an optical axis shift or the like mainly caused by a positional shift due to machine work accuracy occurs. Such an optical axis shift induces a reception light quantity ratio variation between the irradiation power of the laser diode 8 and the front monitor photo diode 9 but with use of the first calibration coefficient calculated in the first calibration coefficient calculation process, it is possible to correct (calibrate) the above-mentioned reception light quantity ratio variation.

However, depending on an optical mechanism design of the optical head 4, if the optical or mechanical adjustment such as the positional adjustment is not performed, the reception light quantity ratio variation between the irradiation power of the laser diode 8 and the front monitor photo diode 9 may exceed 100%. In such a case, the value exceeds the input range of the ADC 47 or the AD conversion value becomes extremely small, thereby decreasing an effective resolution.

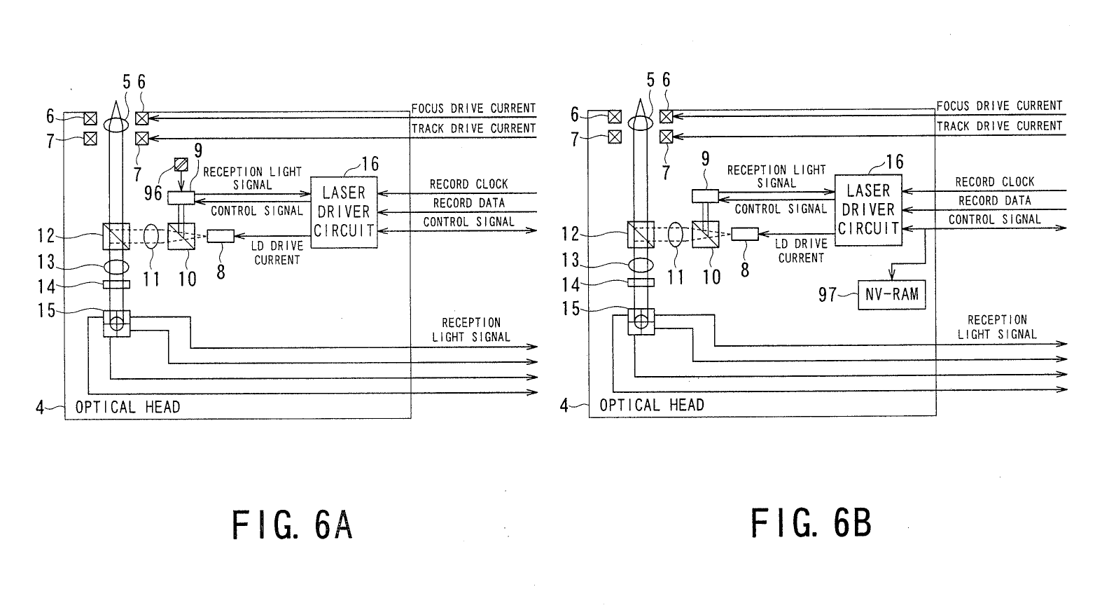

In view of the above, as illustrated in FIG. 6A, a sensitivity adjusting variable resistor VR 96 is provided to the front monitor photo diode 9, thereby conducting the sensitivity adjustment. The sensitivity adjustment based on the sensitivity adjusting variable resistor VR 96 is performed in prior to the first calibration coefficient calculation process executed in the power calibration device 91 of FIG. 3, so that the output of the front monitor photo diode 9 falls within a predetermined range at a certain irradiation power from the objective lens 5. In the adjustment at this time, the calibration with use of the calibration coefficient is performed afterwards and the allowable error range after the adjustment is eased as compared with the necessary irradiation power accuracy. Therefore, the labor hour necessary for the adjustment can be reduced as compared with the conventional case.

This adjustment may be performed while the operator observes the AD conversion value displayed on the display device 95 or the sensitivity adjusting variable resistor VR 96 is composed of an element in which the resistance value can be electronically varied so that the host computer 92 performs the control for adjustment. Furthermore, instead of using the AD conversion value of the ADC 47, the output of the front monitor photo diode 9 is measured by a voltage indicator provided outside the optical head 4, and the adjustment may be performed so that the output of the measured value falls with in the allowable range. Also, in the optical head 4 corresponding to the plurality of wavelengths, the sensitivity adjusting variable resistor VR 96 may be provided for the respective wavelengths, or one sensitivity adjusting variable resistor VR 96 may be provided while corresponding to some wavelengths.

It should be noted that in the first calibration coefficient calculation process described with use of the flowchart of FIG. 4, the case of using the current source 78 which is mainly used at the time of the reproduction has been described. In a case where the current sources 80 and 81 and the like which are mainly used at the time of the recording as well, there is an influence due to an off-set of the respective systems, the gain dispersion of the variable gain SW 51, etc., and thus the first calibration coefficient calculation process is similarly executed.

In particular, in a case where the front monitor photo diode 9 is controlled to switch over the sensitivities at the time of recording and at the time of reproduction or the variable gain SW 51 is used while being switched corresponding to different irradiation powers depending on the recording media, it is necessary to calculate the individual first calibration coefficients in the respective cases. In any case, the relation between the AD conversion value and the irradiation power from the objective lens 5 of the optical head 4 is approximated by way of a straight line and its inclination αᵣ [mW/digit] and its intercept βᵣ [digit] are calculated as the first calibration coefficient.

Incidentally, the calibration coefficient calculated in the first calibration coefficient calculation process is stored in, for example, a NV-RAM 97 that is a non-volatile memory in the optical head 4 as illustrated in FIG. 4B. Alternatively, in a case where assembly of the optical head 4 and mounting of the optical head 4 to the optical disc device 1 are performed in separated places, these values are separated for each of the optical heads 4 and held (stored) in associated with one another. Then, at the time of mounting the drive, a set (the inclination αᵣ and the intercept βᵣ) of the first calibration coefficient of a desired optical head 4 previously stored in the optical disc device 1 is sequentially transferred.

Of course, the thus obtained first calibration coefficient may be converted into, for example, a two dimensional barcode (so-called QR code, etc.) to be affixed to the optical head 4 or the like. Also, the host computer 92 may record the thus obtained first calibration coefficient together with, for example, a manufacturing number in an internal recording medium such as an HDD and perform a communication or use a portable external recording medium to store the first calibration coefficient and the manufacturing number in the non-volatile memory NV-RAM 30 from the host device 34 via the interface circuit 32 at the time of mounting the optical head 4 to the optical disc device 1.

However, the variable gain SW 51 has four options in FIG. 2. For example, if the sensitivity setting for the front monitor photo diode 9 has two modes and three sets of the first calibration coefficient are intended to be held for each wavelength corresponding to the type of the recording media, it is by itself necessary to store 24 sets of the inclination and the intercept in the optical head 4, which increases the storage (recording) capacity and leads to the cost rise.

In view of the above, for obtaining the first calibration coefficient in a case of using the current source 77 in particular, the output of the front monitor photo diode 9 via the variable gain SW 51 is not measured by the ADC 47, but instead the output of the front monitor photo diode 9 via a variable gain SW 52 is measured by the ADC 47. In this case, the variable gain SW 52 calculates and obtains the first calibration coefficient only in a ×4 mode, for example, in the example of FIG. 2, in the vicinity of the center of the setting range of the variable gain SW 51 to be used at the time of the recording. If the input of the ADC 47 selected by an ADC input switching SW 53 is performed immediately after the variable gain SW 52, the variable gain SW 51 and the variable gain SW 52 can be independently set. Therefore, after the built-in of the optical disc device 1, similarly, the outputs of the variable gain SW 51 and the variable gain SW 52 at the irradiation power are switched over by the ADC input switching SW 53 to be measured by the ADC 47, thus making it possible to obtain the first calibration coefficient.

With this configuration, when the first calibration coefficient of the optical head 4 is obtained, it is unnecessary to perform the calculation process on all the gains that can be switched over by the variable gain SW 52. For example, it suffices that the sensitivity setting of the front monitor photo diode 9 has two modes, the variable gain SW has one mode, and three sets of the first calibration coefficient are prepared for the respective wavelengths in accordance with the type of the recording media. Thus, the number of calibration coefficient sets that should be stored can be reduced by one fourth. Then, it is possible to cut down the recording areas for the first calibration coefficient and shorten the process time due to the reduction in the number of times for performing the measurement.

Incidentally, in order to calculate the reference value input to the inside of the laser driver circuit for obtaining the laser light having the predetermined irradiation power by using the calibration coefficients that indicate various manufacturing errors, in addition to the first calibration coefficient derived by the relation between the AD conversion value and the irradiation power from the objective lens 5 of the optical head 4, it is necessary to calculate a second calibration coefficient derived from a relation between the set value of a PEAK APC DAC 54, the ERASE APC DAC 56, or the READ APC DAC 58 and the irradiation power from the objective lens 5 of the optical head 4.

In view of the above, with use of the first calibration coefficient derived by the relation between the AD conversion value and the irradiation power from the objective lens 5 of the optical head 4 which is calculated in the first calibration coefficient calculation process performed on the basis of the flowchart of FIG. 4, the second calibration coefficient derived from the relation between the set values of the PEAK APC DAC 54, the ERASE APC DAC 56, and the READ APC DAC 58 and the irradiation power from the objective lens 5 of the optical head 4. Hereinafter, this second calibration coefficient calculation process will be described.

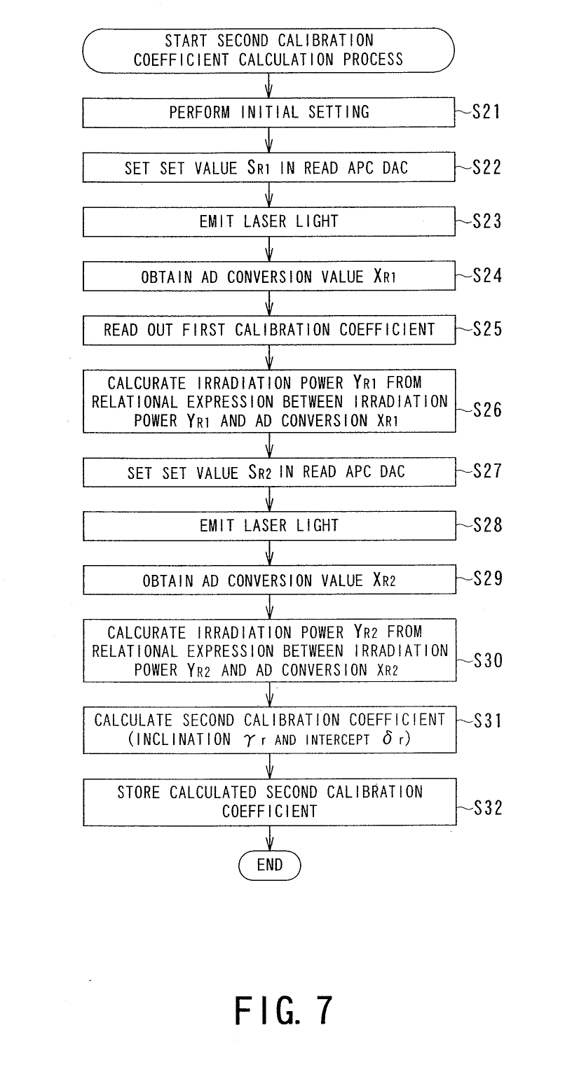

While referring to a flowchart of FIG. 7, the second calibration coefficient calculation process in the optical disc device 1 of FIG. 1 will be described. This second calibration coefficient calculation process is set to be started, after the optical head 4 is mounted to the optical disc device 1, when the operator operates the input unit (not shown) in the host device 34 and issues an instruction to start the second calibration coefficient calculation process.

It should be noted that before the second calibration coefficient calculation process is executed, the first calibration coefficient calculated in the first calibration coefficient calculation process is stored (held) in the NV-RAM 30 that is a non-volatile memory of the optical disc device 1. In a case where the first calibration coefficient is already stored in the NV-RAM 97 in the optical head 4 (FIG. 6B), the stored first calibration coefficient is read by the CPU 27, the read out first calibration coefficient is stored (held) in the NV-RAM 30 that is a non-volatile memory on the side of the optical disc device 1. If the first calibration coefficient is stored (held) in another external recording medium, for example, the first calibration coefficient is stored in the NV-RAM 30 from the host device 34 via the interface circuit 33.

In Step S21, the CPU 27 uses the current source 78 to perform the initial setting necessary for irradiating the laser light from the laser diode 8 with respect to the laser diode 8 and the laser driver circuit 16 inside the optical head 4.

In Step S22, the CPU 27 generates a READ APC DAC set control signal for setting a set value S_{R1} as a DAC set value in the READ APC DAC 58 and supplies the thus generated READ APC DAC setting control signal via the signal bus 26 to the optical head 4.

On the basis of the READ APC DAC setting control signal supplied from the CPU 27, the optical head 4 sets the set value S_{R1} in the READ APC DAC 58 as the DAC set value.

In Step S23, in accordance with the control of the CPU 27, the laser driver circuit 16 of the optical head 4 supplies an LD drive current generated with use of the set value S_{R1} thus set, to the laser diode 8. The laser diode 8 of the optical head 4 uses the LD drive current supplied from the laser driver circuit 16 to emit the laser light via the objective lens 5 for irradiation.

In Step S24, the front monitor photo diode 9 of the optical head 4 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 of the optical head 4 obtains the reception light signal supplied from the front monitor photo diode 9, performs AD (analog digital) conversion on the reception light signal obtained by the ADC 47 via the LPF 43 and the S/H 46, and supplies the AD conversion value X_{R1} after the conversion to the CPU 27 via the signal bus 26.

The CPU 27 obtains an AD conversion value X_{R1} supplied from the optical head 4 via the signal bus 26.

In Step S25, the CPU 27 reads out the first calibration coefficient previously stored in the NV-RAM 30. In Step S26, from the relational expression (Y_{R1}=αᵣ×X_{R1}+βᵣ) between the irradiation power Y_{R1} and the AD conversion value X_{R1} derived from the read out first calibration coefficient, the CPU 27 calculates the irradiation power Y_{R1} by using the thus obtained AD conversion value X_{R1}.

In Step S26, the CPU 27 generates a READ APC DAC setting control signal for setting the set value S_{R2} in the READ APC DAC 58 as the DAC set value and supplies the thus generated READ APC DAC setting control signal via the signal bus 26 to the optical head 4.

On the basis of the READ APC DAC setting control signal supplied from the CPU 27, the optical head 4 sets the set value S_{R2} in the READ APC DAC 58 as the DAC set value.

In Step S27, in accordance with the control of the CPU 27, the laser driver circuit 16 of the optical head 4 supplies the LD drive current generated by using the set value S_{R2} thus set, to the laser diode 8. The laser diode 8 of the optical head 4 uses the LD drive current supplied from the laser driver circuit 16 to emit the laser light via the objective lens 5 for irradiation.

In Step S28, the front monitor photo diode 9 of the optical head 4 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 of the optical head 4 obtains the reception light signal supplied from the front monitor photo diode 9, performs AD (analog digital) conversion on the reception light signal obtained by the ADC 47 via the LPF 43 and the S/H 46, and supplies the AD conversion value X_{R2} after the conversion to the CPU 27 via the signal bus 26.

The CPU 27 obtains an AD conversion value X_{R2} supplied from the optical head 4 via the signal bus 26.

In Step S29, the CPU 27 reads out the calibration coefficient previously set in the NV-RAM 30. In Step S30, from the relational expression (Y_{R2}=αᵣ×X_{R2}+βᵣ) between the irradiation power Y_{R2} and the AD conversion value X_{R2} derived from the read out calibration coefficient, the CPU 27 calculates the irradiation power Y_{R2} by using the thus obtained AD conversion value X_{R2}.

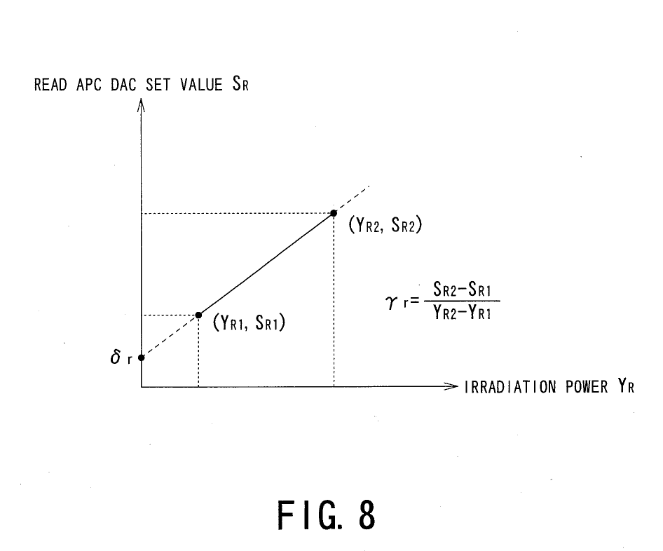

In Step S31, the CPU 27 uses the set value S_{R1} and the irradiation power Y_{R1} set in the READ APC DAC 58 as the DAC set value and the set value S_{R1} and the irradiation power Y_{R1} set in the READ APC DAC 58 as the DAC set value to approximate the relation between the set value SR and the irradiation power Y_{R} by way of a straight line as illustrated in FIG. 8 for calculating its inclination γᵣ [digit/mW] and its intercept 6r [digit] as the second calibration coefficient.

In Step S32, the CPU 27 stores the calculated second calibration coefficient in the NV-RAM 30 of the optical disc device 1 while being associated with the first calibration coefficient. In accordance with the control of the CPU 27, the NV-RAM 30 stores the calculated second calibration coefficient while being associated with the first calibration coefficient.

It should be noted that in the second calibration coefficient calculation process described with use of the flowchart of FIG. 7, the DAC set value and the irradiation power are obtained in the READ APC DAC 58 at two points for the straight-line approximation, but the calibration coefficient may be calculated through the least square approximation through the obtainment at more than two points. As a result, it is possible to suppress the influence caused by the observation noise.

Also, in the second calibration coefficient calculation process described with use of the flowchart of FIG. 7, the description has been given of the case where the current source 78, which is mainly used at the reproduction, is used. In a case where the current sources 80 and 81 and the like which are mainly used at the time of the recording as well, there is an influence due to an off-set of the respective systems, the gain dispersion of the variable gain SW 51, etc., and thus the second calibration coefficient calculation process is similarly executed.

In particular, in a case where the front monitor photo diode 9 is controlled to switch over the sensitivities at the time of recording and at the time of reproduction or the variable gain SW 51 is used while being switched corresponding to different irradiation powers depending on the recording media, it is necessary to calculate the individual second calibration coefficients in the respective cases. In any case, the relation between the DAC set value and the irradiation power from the objective lens 5 of the optical head 4 is approximated by way of a straight line to calculate its inclination γᵣ [digit/mW] and its intercept δᵣ [digit] as the second calibration coefficient.

In this way, as it becomes possible to obtain the calibration coefficients (the first calibration coefficient, the second calibration coefficient, and the like), in the assembly step or the like, the adjustment for setting a certain irradiation power from the objective lens 5 with respect to a certain DAC set value is unnecessary. In addition, it is possible to compensate the influence due to the off-set and the gain dispersion of various DACs, the variable gain SW, the S/H, and the like in the laser driver circuit 16 and prepare the optical disc device 1 having a resistance to the dispersion of the components, thus achieving the simplification in the manufacture and the cost reduction.

Incidentally, when the LD drive current is output to the laser diode 8 in the laser driver circuit 16 with use of the current sources 76 to 78, the second calibration coefficient derived from the relation between the set values of the PEAK APC DAC 54, the ERASE APC DAC 56, and the READ APC DAC 58 and the irradiation power from the objective lens 5 of the optical head 4 is calculated. In a case where the LD drive current is output to the laser diode 8 in the laser driver circuit 16 with use of the current source 79, the comparison amplifier does not exist and the APC cannot be used. As the LD drive current is controlled by setting the value computed by the CPU 27 in a BOTTOM ACC DAC 60, it is necessary to previously find out the relation of the actually flowing LD drive current with respect to the set value the BOTTOM ACC DAC 60. In addition, it is necessary to calculate a third calibration coefficient derived from this relation. Hereinafter, this third calibration coefficient calculation process will be described.

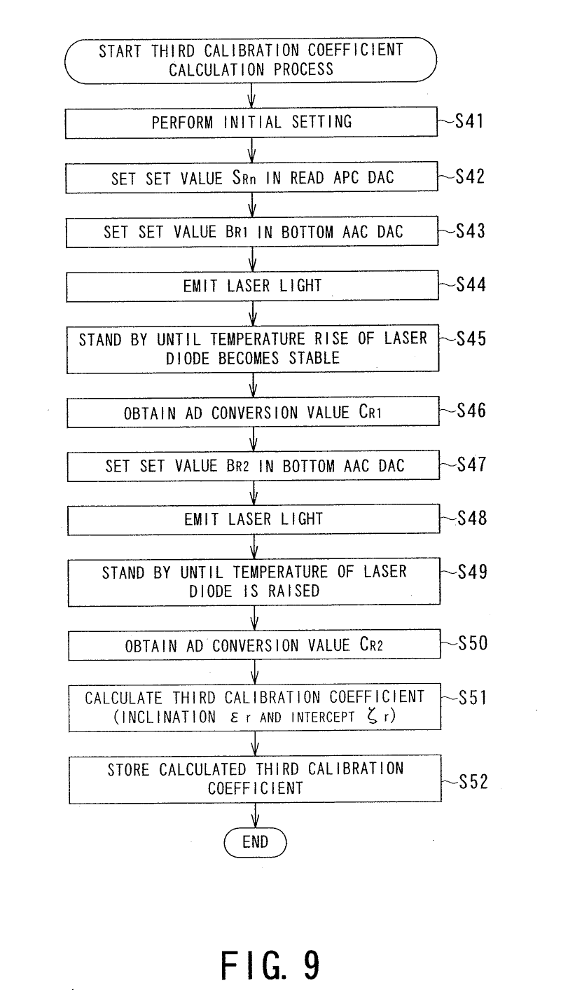

With reference to a flowchart of FIG. 9, the third calibration coefficient calculation process in the optical disc device 1 of FIG. 1 will be described. This third calibration coefficient calculation process is set to be started, after the optical head 4 is mounted to the optical disc device 1, when the operator operates the input unit (not shown) in the host device 34 and issues an instruction to start the third calibration coefficient calculation process.

In Step S41, with respect to the laser diode 8 and the laser driver circuit 16 inside the optical head 4, the CPU 27 uses the current source 78 and the current source 79 at the same time to perform an initial setting for emitting the laser light from the laser diode 8.

In Step S42, the CPU 27 generates a READ APC DAC setting control signal for setting a set value S_{Rn} in the READ APC DAC 58 as the DAC set value and supplies the thus generated READ APC DAC setting control signal via the signal bus 26 to the optical head 4.

On the basis of the READ APC DAC setting control signal supplied from the CPU 27, the optical head 4 sets the set value S_{Rn} in the READ APC DAC 58 as the DAC set value.

In Step S43, the CPU 27 generates a BOTTOM ACC DAC setting control signal for setting a set value B_{R1} in the BOTTOM ACC DAC 60 as an ACC set value and supplies the thus generated BOTTOM ACC DAC setting control signal via the signal bus 26 to the optical head 4.

In Step S44, in accordance with the control of the CPU 27, the laser driver circuit 16 of the optical head 4 uses the set value S_{Rn} thus set and the set value B_{R1} to supply the thus generated LD drive current to the laser diode 8. The laser diode 8 of the optical head 4 uses the LD drive current supplied from the laser driver circuit 16 to emit the laser light via the objective lens 5 for irradiation.

In general, a current-irradiation power characteristic of the laser diode 8 (I-L characteristic) depends on the temperature, but after the elapse of a thermally stable time under conditions of a constant environment temperature and a constant irradiation power, the temperature becomes almost constant. Thus, it is possible to consider that a current for obtaining a constant power is constant. Therefore, it is possible to consider that the increase or decrease in the LD drive current output from the current source 79 is equal to the increase or decrease in the LD drive current output from the current source 78.

For that reason, the LD drive current output from the current source 79 and the LD drive current output from the current source 78 are supplied to the laser diode 8 at the same time, due to the effect of the APC control, the increase or decrease in the LD drive current output from the current source 78 is caused at the same amount of the increase or decrease in the LD drive current output from the current source 79 and the constant irradiation power corresponding to the set value for the READ APC DAC 58 is emitted from the objective lens 5.

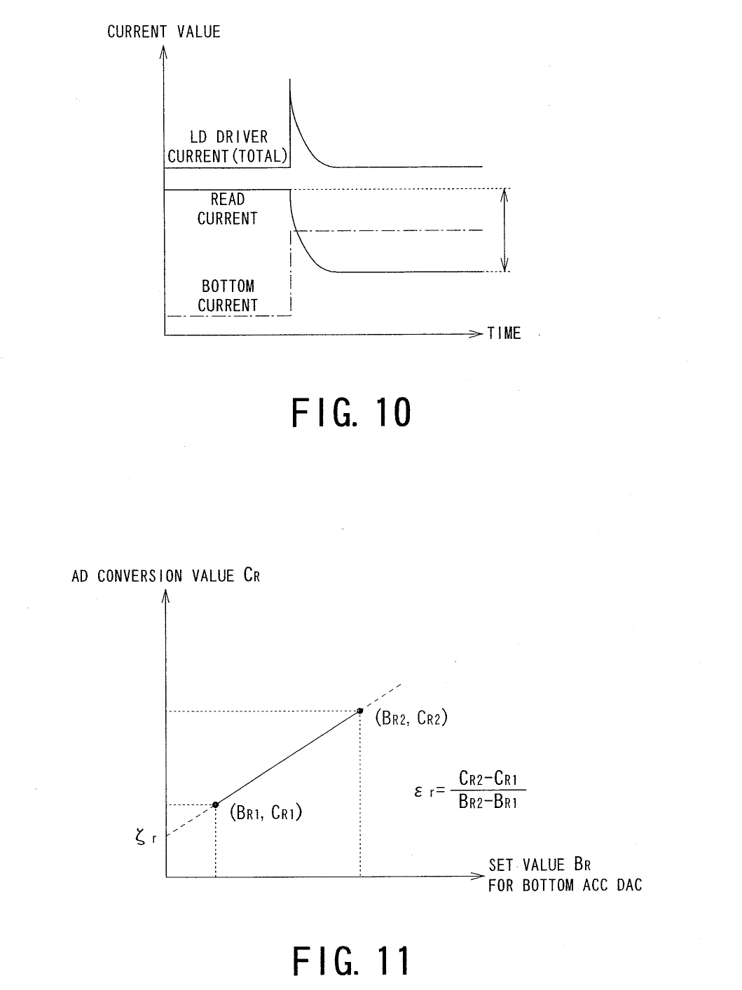

Herein, as illustrated in FIG. 10, if the relation [mA/digit] of the LD drive current that is the output from the current source 79 with respect to 1 [digit] of the BOTTOM ACC DAC 60 is already known, due to a change in a reference voltage value V_{bc} of the current source 79, it is possible to measure with use of the ADC 47 a change of a reference voltage value Vᵣₚ to the current source 78 where the APC is executed, obtain the change amount in a change amount [digit/digit] in the ADC 47 of the reference voltage value Vᵣₚ with respect to the change in the BOTTOM ACC DAC 60, and calculate a third calibration coefficient [mA/digit] for converting the AD conversion value in which the reference voltage value Vᵣₚ to the current source 78 is measured by the ADC 47 into a current value [mA].

In Step S45, the CPU 27 determines whether or not a predetermined time previously set during which it is possible to consider that the current necessary for obtaining the constant power is constant elapses with use of a built-in timer (not shown in the drawing) and stands by until the temperature rise of the laser diode 8 becomes stable.

In Step S46, the front monitor photo diode 9 of the optical head 4 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 of the optical head 4 obtains the reception light signal supplied from the front monitor photo diode 9, performs AD (analog digital) conversion on the reception light signal obtained by the ADC 47 via the LPF 43 and the S/H 46, and supplies an AD conversion value C_{R1} after the conversion to the CPU 27 via the signal bus 26.

The CPU 27 obtains the AD conversion value C_{R1} supplied from the optical head 4 via the signal bus 26.

In Step S47, the CPU 27 generates a BOTTOM ACC DAC setting control signal for setting a set value B_{R2} in the BOTTOM ACC DAC 60 as the ACC set value and supplies the thus generated BOTTOM ACC DAC setting control signal via the signal bus 26 to the optical head 4.

In Step S48, in accordance with the control of the CPU 27, the laser driver circuit 16 of the optical head 4 uses the set value S_{Rn} and the set value B_{R2} to supply the thus generated LD drive current to the laser diode 8. The laser diode 8 of the optical head 4 uses the LD drive current supplied from the laser driver circuit 16 to emit the laser light via the objective lens 5 for irradiation.

In Step S49, the CPU 27 determines whether or not the predetermined time previously set during which it is possible to consider that the current necessary for obtaining the constant power is constant elapses with use of the built-in timer (not shown in the drawing) and stands by until the temperature rise of the laser diode 8 becomes stable.

In Step S50, the front monitor photo diode 9 of the optical head 4 divides a part of the laser light generated by the laser diode 8 with use of the half mirror 10 at a given ratio, detects a reception light signal in proportion to the light quantity, that is, the irradiation power, and supplies the detected reception light signal to the laser driver circuit 16. The laser driver circuit 16 of the optical head 4 obtains the reception light signal supplied from the front monitor photo diode 9, performs AD (analog digital) conversion on the reception light signal obtained by the ADC 47 via the LPF 43 and the S/H 46, and supplies an AD conversion value C_{R2} after the conversion to the CPU 27 via the signal bus 26.

The CPU 27 obtains the AD conversion value C_{R2} supplied from the optical head 4 via the signal bus 26.

In Step S51, the CPU 27 uses the AD conversion value C_{R1} and the set value B_{R1} set in the BOTTOM ACC DAC 60 as the DAC set value, and the AD conversion value C_{R2} and the set value B_{R2} set in the BOTTOM ACC DAC 60 as the DAC set value to approximate a relation between an AD conversion value C_{R} and a set value B_{R} by way of a straight line as illustrated in FIG. 11 to calculate its inclination εᵣ [mA/digit] and its intercept ζᵣ [digit] as the third calibration coefficient.

In Step S52, the CPU 27 stores the calculated third calibration coefficient in the NV-RAM 30 of the optical disc device 1 while being associated with the first calibration coefficient and the second calibration coefficient. The NV-RAM 30 stores the calculated third calibration coefficient while being associated with the first calibration coefficient and the second calibration coefficient in accordance with the control of the CPU 27.

After a reference voltage value Vᵣₚ to the current source 78 is measured by the ADC 47 with use of the third calibration coefficient, if the reference voltage value is converted into a current value [mA] or an equivalent value [digit] of the set value for the BOTTOM ACC DAC 60, it is possible to easily obtain the set value for the BOTTOM ACC DAC 60 necessary to output a current equivalent to the LD drive current which is output by using the APC in the current source 78 in the current source 79. Also, in general, a reference voltage-output current calibration coefficient (transconductance) of the respective current sources has large manufacturing dispersion. The manufacturing dispersion can be allowed with the calibration based on such a calibration coefficient. Also, without using the manpower, the manufacturing errors and the like can be calibrated, thereby achieving the improvement in the manufacturing yield and the reduction in the manufacturing costs.

It should be noted that in the third calibration coefficient calculation process described with use of the flowchart of FIG. 9, the ACC set value and the irradiation power are obtained at two points in the BOTTOM ACC DAC 60 for the straight-line approximation, but the calibration coefficient may be calculated through the least square approximation through the obtainment at more than two points. As a result, it is possible to suppress the influence caused by the observation noise.

In the third calibration coefficient calculation process described with use of the flowchart of FIG. 9, the thus obtained intercept has a value which depends on the measurement condition. Thus, the real intercept of the third calibration coefficient cannot be obtained. However, in general, the intercept of the third calibration coefficient can be assumed as 0 in many cases. Thus, only the inclination εᵣ [mA/digit] may be calculated without calculating the intercept ζᵣ [digit].

Incidentally, in a case where the irradiation power control is executed without using the APC control in any one of the current sources 76 to 78 (refer to Japanese Patent Application 2006-152758), the set value for any one of a PEAK ACC DAC 55, the ERASE ACC DAC 57, and the READ ACC DAC 59 is set through the computation of the CPU 27. In this case, the relation between the set value and the respective ACC current reference values is unclear due to the off-set and the gain dispersion of the respective ACC DACs. In addition, the relation with respect to the LD drive current is also unclear due to the manufacturing dispersion such as the reference voltage-output current calibration coefficient (transconductance) of the current sources 76 to 79 and the like.

In view of the above, the relation between the set values for the respective ACC DACs and the LD drive current that is the output from the current sources 76 to 79 is obtained, and a fourth calibration coefficient is calculated from the thus obtained relation. Hereinafter, a fourth calibration coefficient calculation process by using this method will be described.

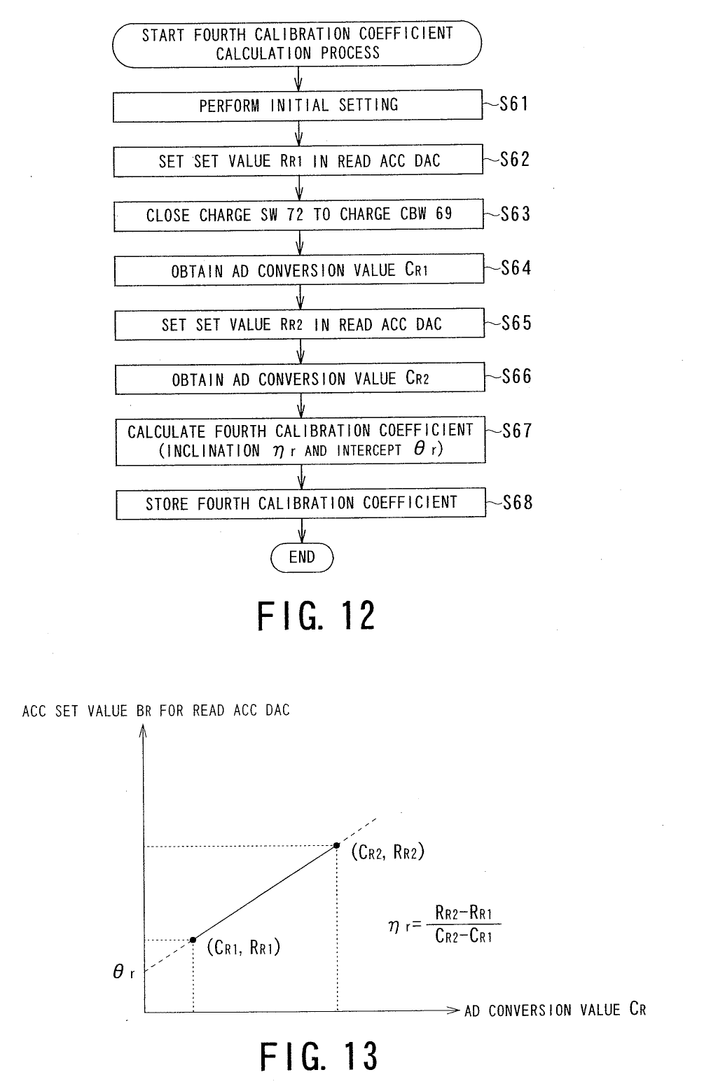

While referring to a flowchart of FIG. 12, the fourth calibration coefficient calculation process in the optical disc device 1 of FIG. 1 will be described. This fourth calibration coefficient calculation process is set to be started, after the optical head 4 is mounted to the optical disc device 1, when the operator operates the input unit (not shown) in the host device 34 and issues an instruction to start the fourth calibration coefficient calculation process.

In Step S61, with respect to the laser diode 8 and the laser driver circuit 16 in the optical head 4, the CPU 27 uses the current source 78 to perform the initial setting necessary for irradiating the laser light from the laser diode 8.

In Step S62, the CPU 27 generates a READ ACC DAC setting control signal for setting a set value R_{R1} in the READ ACC DAC 59 as the ACC set value and supplies the thus generated READ ACC DAC setting control signal via the signal bus 26 to the optical head 4.

The optical head 4 sets the set value R_{R1} in the READ APC DAC 58 as the ACC set value on the basis of the READ ACC DAC setting control signal supplied from the CPU 27.

In Step S63, the CPU 27 controls the laser driver circuit 16 to close a charging SW 72 for charging a CBW 69. In Step S64, the CPU 27 controls the laser driver circuit 16, measures an ACC current reference value V_{rc} with use of the ADC 47 via the charging SW 72, converts the measured value into the AD conversion value C_{R1}, and supplies the AD conversion value C_{R1} after the conversion to the CPU 27 via the signal bus 26.

The CPU 27 obtains an AD conversion value C_{R1} supplied from the optical head 4 via the signal bus 26.

In Step S65, the CPU 27 generates a READ ACC DAC setting control signal for setting a set value R_{R2} in the READ ACC DAC 59 as the ACC set value and supplies the thus generated READ ACC DAC setting control signal via the signal bus 26 to the optical head 4.

On the basis of the READ ACC DAC setting control signal supplied from the CPU 27, the optical head 4 sets the set value R_{R2} in the READ ACC DAC 59 as the ACC set value.

In Step S66, the CPU 27 controls the laser driver circuit 16 to close the charging SW 72 for charging the CBW 69. In Step S64, the CPU 27 controls the laser driver circuit 16, measures the ACC current reference value V_{rc} with use of the ADC 47 via the charging SW 72, converts the measured value into the AD conversion value C_{R2}, and supplies the AD conversion value C_{R2} after the conversion to the CPU 27 via the signal bus 26.

The CPU 27 obtains an AD conversion value C_{R2} supplied from the optical head 4 via the signal bus 26.

In Step S67, the CPU 27 uses the set value R_{R1} set in the READ ACC DAC 59 as the ACC set value and the AD conversion value C_{R1}, and the set value R_{R2} set in the READ ACC DAC 59 as the ACC set value and the AD conversion value C_{R2} to approximate a relation between the set value R_{R1} and the AD conversion value C_{R1} by way of a straight line as illustrated in FIG. 13 for calculating its inclination ηᵣ [digit/digit] and its intercept θᵣ [digit] as a calibration coefficient.

Then, the relation of the LD drive current output with respect to the reference value of the current source 78 or the relation with respect to the set value for the BOTTOM ACC DAC 60 is obtained from the third calibration coefficient calculation process described with use of the flowchart of FIG. 9. Therefore, from the relation [digit/digit] of the AD conversion value with respect to the set value for the READ ACC DAC 59, it is possible to calculate the relation [digit/mA] of the LD drive current output with respect to the set value for the READ ACC DAC 59 or the relation [digit/digit] of the BOTTOM ACC DAC 60 with respect to the READ ACC DAC 59.

In Step S68, the CPU 27 stores the calculated the fourth calibration coefficient in the NV-RAM 30 of the optical disc device 1. The NV-RAM 30 stores the calculated fourth calibration coefficient in accordance with the control of the CPU 27. It should be noted that the NV-RAM 30 may store various coefficients calculated by using the fourth calibration coefficient or the like at the same time.

As a result, in a case where the transconductance of the current source 79 is already known, even if transconductances of other current sources are unknown and the respective ACC DACs have the off-set or gain error, it is possible to calculate the relation of the LD output current with respect to the set values for the respective ACC DACs. Therefore, the off-set or gain error can be allowed in the respective ACC DACs and the condition hardly depends on the manufacturing dispersion of the laser driver circuits 16, thereby making it possible to improve the manufacturing yield and reduce the manufacturing costs.

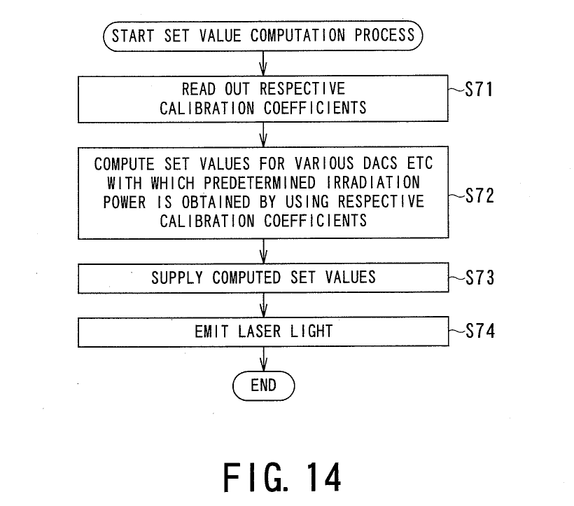

Next, with reference to a flowchart of FIG. 14, a set value computation process in the optical disc device 1 of FIG. 1 will be described. This set value computation process is subsequently started after the optical head 4 is mounted to the optical disc device 1 and the second to fourth calibration coefficient calculation processes are executed when an instruction of recording or reproducing of the optical disc 33 is issued when the operator operates the input unit (not shown) in the host device 34.

In Step S71, the CPU 27 reads out the respective calibration coefficients (the first to fourth calibration coefficients and the like) previously stored in the NV-RAM 30.

In Step S72, the read out respective calibration coefficients (the first to fourth calibration coefficients and the like) are used to compute the set values for various DACs for preparing the predetermined irradiation power required at the time of the recording or reproduction.

In Step S73, the CPU 27 supplies the computed set value to the various DACs (for example, the READ APC DAC 58 and the like) via the signal bus 26.

In Step S74, in accordance with the control of the CPU 27, the laser driver circuit 16 of the optical head 4 uses the set value for the set various DACs to supply the thus generated LD drive current to the laser diode 8. The laser diode 8 of the optical head 4 uses the LD drive current supplied from the laser driver circuit 16 to emit the laser light via the objective lens 5 for irradiation.

According to the embodiments of the present invention, such a configuration is not adopted that an adjustment is performed so that a constant output (the irradiation power, the LD drive current) is obtained if a certain value is set for various DACs in the laser driver circuit 16 or the manufacturing dispersion is suppressed. Instead, a relation between the set values for the various DACs and the output is measured, and calibration coefficients (for example, the first to fourth calibration coefficients and the like) with which the CPU 27 can compute the set values for the various DAC are calculated so that a constant output can be obtained from the relation. As a result, it is possible to appropriately calibrate factors governed by the manufacturing errors at the time of the recording and reproduction such as the incident light quantity ratio variation to the front monitor photo diode 9 with respect to the output light quantity of the laser diode 8 due to the manufacturing and mounting dispersion of the laser diodes 8 and the half mirrors 10, the reception light quantity variation due to the mounting dispersion of the front monitor photo diodes 9, the reception light sensitivity change and output voltage off-set due to the manufacturing dispersion of the front monitor photo diodes 9, the gain variation of the variable gain due to the manufacturing dispersion of the laser driver circuits 16, and the off-set variation in the sample-and-hold, the peak hold, and the variable gain circuit. As a result, it is possible to improve the manufacturing yields of the integrated circuits constituting the laser driver circuits 16, the optical heads 4, and the optical disc devices 1 using the optical heads 4. Furthermore, the costs can be reduced.

Incidentally, in the first calibration coefficient calculation process and the second calibration coefficient calculation process described with use of the flowcharts of FIGS. 4 and 7, the first calibration coefficient derived by the relation between the AD conversion value and the irradiation power from the objective lens 5 of the optical head 4 is calculated, and the calculated first calibration coefficient is used to calculate the second calibration coefficient that is derived from the relation between the set values for the PEAK APC DAC 54, the ERASE APC DAC 56, and the READ APC DAC 58 and the irradiation power from the objective lens 5 of the optical head 4. Without a limitation to such a case, while the order is reversed, such a configuration may be adopted that the second calibration coefficient derived from the relation between the set values for the PEAK APC DAC 54, the ERASE APC DAC 56, and the READ APC DAC 58 and the irradiation power from the objective lens 5 of the optical head 4 is calculated and the calculated second calibration coefficient is used to calculate the first calibration coefficient derived by the relation between the AD conversion value and the irradiation power from the objective lens 5 of the optical head 4. Alternatively, for example, the second calibration coefficient derived from the relation between the set values for the PEAK APC DAC 54, the ERASE APC DAC 56, and the READ APC DAC 58 and the irradiation power from the objective lens 5 of the optical head 4 may be directly calculated so that the present invention can be applied to such a case that the ADC and the like are not provided to the laser driver circuit 16. Hereinafter, the second calibration coefficient calculation process for directly calculating the second calibration coefficient derived from the relation between the set values for the respective APC DACs and the irradiation power will be described.

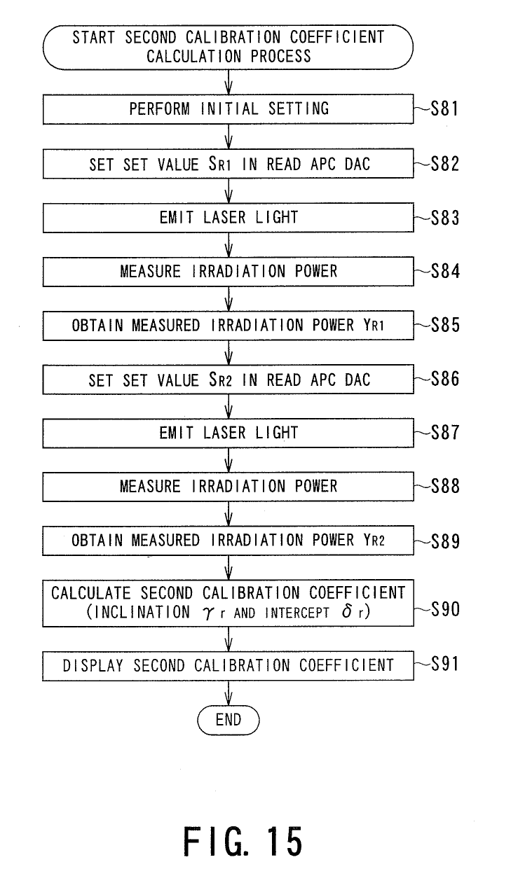

With reference to a flowchart of FIG. 15, the second calibration coefficient calculation process in the power calibration device 91 of FIG. 3 will be described.

In Step S81, with respect to the laser diode 8 and the laser driver circuit 16 inside the optical head 4, the host computer 92 uses the current source 78 to perform the initial setting necessary for irradiating the laser light from the laser diode 8.

In Step S82, the host computer 92 generates a READ APC DAC setting control signal for setting the set value S_{R1} in the READ APC DAC 58 as the DAC set value and outputs the thus generated READ APC DAC set control signal to the optical head 4.

On the basis of the READ APC DAC setting control signal input from the host computer 92, the optical head 4 sets the set value S_{R1} in the READ APC DAC 58 as the DAC set value.

In Step S83, in accordance with the control of the host computer 92, the laser driver circuit 16 of the optical head 4 supplies an LD drive current generated with use of the set value S_{R1} thus set, to the laser diode 8. The laser diode 8 of the optical head 4 uses the LD drive current supplied from the laser driver circuit 16 to emit the laser light via the objective lens 5 for irradiating the power meter 93 with the laser light.

In Step S84, the power meter 93 measures the irradiation power of the laser light irradiated from the laser diode 8 and supplies the thus measured irradiation power Y_{R1} to the host computer 92.

In Step S85, the host computer 92 obtains the irradiation power Y_{R1} supplied from the power meter 93.

Next, in Step S86, similarly, the host computer 92 generates a READ APC DAC setting control signal for setting a set value S_{R2} in the READ APC DAC 58 as the DAC set value and outputs the thus generated READ APC DAC set control signal to the optical head 4.

On the basis of the READ APC DAC setting control signal input from the host computer 92, the optical head 4 sets the set value S_{R2} in the READ APC DAC 58 as the DAC set value.

In Step S87, the laser driver circuit 16 of the optical head 4 supplies an LD drive current generated with use of the set value S_{R1} thus set, to the laser diode 8. The laser diode 8 of the optical head 4 uses the LD drive current supplied from the laser driver circuit 16 to emit the laser light via the objective lens 5 for irradiating the power meter 93 with the laser light.

In Step S88, the power meter 93 measures the irradiation power of the laser light irradiated from the laser diode 8 and supplies the thus measured irradiation power Y_{R2} to the host computer 92.

In Step S89, the host computer 92 obtains the irradiation power Y_{R2} supplied from the power meter 93. In Step S11, the host computer 92 obtains the AD conversion value X_{R2} supplied from the optical head 4 via the interface circuit 94.

In Step S90, the CPU 27 uses the set value S_{R1} set in the READ APC DAC 58 as the DAC set value and the irradiation power Y_{R1}, and the set value S_{R1} set in the READ APC DAC 58 as the DAC set value and the irradiation power Y_{R1} to approximate the relation between the set value SR and the irradiation power Y_{R}, for example, by way of a straight line as illustrated in FIG. 8 for example for calculating its inclination γᵣ [digit/mW] and its intercept δᵣ [digit] as the second calibration coefficient.

In Step S91, the host computer 92 causes the display device 95 to display the calculation result of the second calibration coefficient. The display device 95 displays the calculation result of the second calibration coefficient in accordance with the control of the host computer 92. As a result, the operator can find out the calculation result of the second calibration coefficient of the optical head 4 that is the power calibration target.

As a result, the set value for the READ APC DAC 58 is associated with the measured value of the irradiation power from the objective lens 5 of the optical head 4 measured by the power meter 93 at that time to approximate the relation between the DAC set value and the irradiation power from the objective lens 5 of the optical head 4 by way of a straight line, thereby making it possible to directly calculate its inclination γᵣ [mW/digit] and its intercept δᵣ [digit] as the calibration coefficient.

According to the embodiments of the present invention, the calibration coefficient for the APC DAC set value is directly measured and obtained by the power meter 93, and therefore it is possible to decrease the risk of excess irradiation due to the calibration coefficient dispersion (abnormality) as compared with the case where the second calibration coefficient of the irradiation power is calculated through the conversion with use of the ADC 47.

It should be noted that after the optical head 4 is built in the optical disc device 1, the power meter 93 may be used to execute the first calibration coefficient calculation process by the host device 34 or the host device 34 or the CPU 27 may execute the second calibration coefficient calculation process.

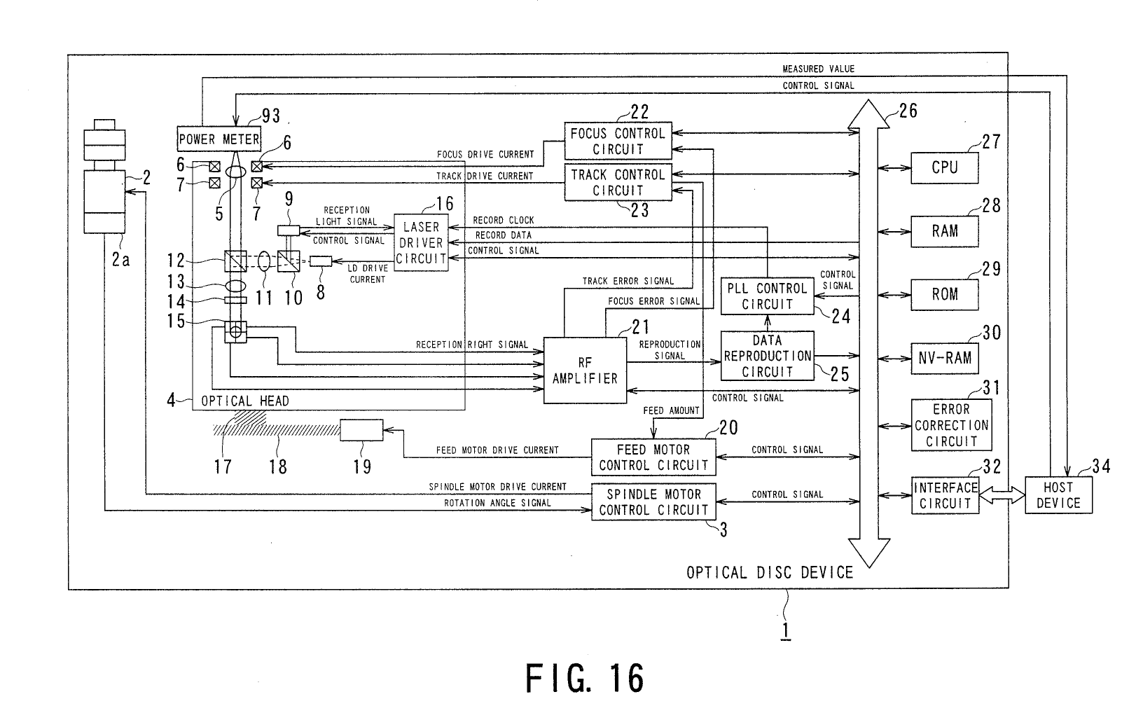

FIG. 16 illustrates a configuration of the optical disc device 1 for executing the first calibration coefficient calculation process by using the power meter 93 after the optical disc device 1 is built in the optical head 4.

As illustrated in FIG. 16, the power meter 93 is adapted to measure the intensity of light emitted from the objective lens 5 of the optical head 4 and supplies the measured value to the host device 34. The host device 34 executes the flowchart of FIG. 4 or 7, obtains the relation between the AD conversion value and the irradiation power of the objective lens 5 when the output of the front monitor photo diode 9 is measured by the ADC 47 or the relation between the APC DAC set value and the irradiation power of the objective lens 5, and calculates the second calibration coefficient derived from the thus obtained relation. The calculated second calibration coefficient is recorded in the NV-RAM 30 that is a non-volatile memory. After that the third calibration coefficient calculation process and the fourth calibration coefficient calculation process described with use of the flowcharts of FIGS. 9 and 12 are appropriately executed.

As a result, it becomes unnecessary to ensure a recording location for the calibration coefficients (the first to fourth calibration coefficients and the like) associated with the optical head 4, thus simplifying the manufacturing steps. Therefore, it is possible to improve the manufacturing yields of the integrated circuits constituting the laser driver circuits 16, the optical heads 4, and the optical disc devices 1 using the optical heads 4. Furthermore, the costs can be reduced.

It should be noted that according to the embodiments of the present invention, the CPU 27 of the optical disc device 1 calculates the second to fourth calibration coefficients. However, without a limitation to such a case, for example, the host device 34 may calculate the second to fourth calibration coefficients.

In addition, it should be noted that the series of the processes described in the embodiments of the present invention can be executed by software, but can also be executed by hardware.

Moreover, according to the embodiments of the present invention, such an example has been described that the steps of the flowchart are executed in the stated order in a time series manner. However, such a case is within the scope of the present invention that the steps are executed in parallel or individually even when the steps are not necessarily executed in the time series manner.

What is claimed is:

1. A laser driver circuit, comprising:
a light emitting unit configured to emit laser light;
a light receiving unit configured to receive the laser light emitted from the light emitting unit and to generate a reception light signal; and
a control unit configured to compare the reception light signal generated by the light receiving unit with a target value related to an irradiation power previously set for the laser light emitted from the light emitting unit and to control a drive signal of the light emitting unit so that the reception light signal matches the target value,
wherein the control unit configured to control the light emitting unit so that the reception light signal matches the target value on the basis of a set value which is computed by using at least one calibration coefficient for matching the reception light signal to the target value.

2. The laser driver circuit according to claim 1, wherein the calibration coefficient comprises a relation between the irradiation power of the laser light emitted by the light emitting unit and the set value.

3. An optical disc device having a laser driver circuit, comprising:
a light emitting unit configured to emit laser light;
a light receiving unit configured to receive the laser light emitted from the light emitting unit and to generate a reception light signal;
a control unit configured to compare the reception light signal generated by the light receiving unit with a target value related to an irradiation power previously set for the laser light emitted from the light emitting unit and to control a drive signal of the light emitting unit so that the reception light signal matches the target value; and
a computation unit configured to compute a set value for matching the reception light signal to the target value by using at least a first calibration coefficient.

4. The optical disc device according to claim 3, wherein the first calibration coefficient comprises a relation between the irradiation power of the laser light emitted by the light emitting unit and the set value.

5. The optical disc device according to claim 4, wherein the optical disc device further comprises a calculation unit configured to calculate a second calibration coefficient comprising a relation between the target value and the set value by using the first calibration coefficient; and
wherein the computation unit is configured to compute the set value for matching the reception light signal to the target value by using the first calibration coefficient and the second calibration coefficient calculated by the calculation unit.

6. The optical disc device according to claim 3, wherein the optical disc device further comprises:
a measurement unit configured to measure a current output to the light emitting unit from first and second current sources; and
a calculation unit configured to calculate a third calibration coefficient comprising a relation between the current measured by the measurement unit and the set value,
wherein the computation unit is configured to calculate the set value for matching the reception light signal to the target value by using the third calibration coefficient calculated by the calculation unit.

7. The optical disc device according to claim 6, wherein the measurement unit comprises an analog-to-digital converter.

8. The optical disc device according to claim 3, further comprising a memory unit configured to store the first calibration coefficient.
